(19) United States
(12) Patent Application Publication
(10) Pub. No.: US 2022/0376269 A1
(43) Pub. Date: Nov. 24, 2022

(54) HIGH-STABILITY CATALYST FOR AN ELECTROCHEMICAL CELL

(71) Applicant: Heraeus Deutschland GmbH & Co. KG, Hanau (DE)

(72) Inventors: Frederic HASCHE, Hanau (DE); Markus NESSELBERGER, Hanau (DE); Nadia KUWERTZ, Hanau (DE); Florian EWEINER, Hanau (DE); Leonarad STOICA, Hanau (DE); Julie MICHAUD-BERNLOCHNER, Hanau (DE); Ciaudia RAMIREZ CASTRO, Hanau (DE); Dominik SAMUELIS, Hanau (DE)

(21) Appl. No.: 17/755,256

(22) PCT Filed: Nov. 4, 2020
(86) PCT No.: PCT/EP2020/080965

§ 371 Date: Apr. 25, 2022

(30) Foreign Application Priority Data
Nov. 4, 2019 (EP) 19206896.3

(51) Int. Cl. H01M 4/92; H01M 4/88; H01M 8/1018; C25B 9/19; C25B 11/081; C25B 11/065; C25B 11/054

(52) U.S. Cl. CPC H01M 4/926; H01M 4/8817; H01M 4/885; H01M 8/1018; C25B 9/19; C25B 11/081; C25B 11/065; C25B 11/054; H01M 2008/1095

(57) ABSTRACT

The present invention relates to a method for producing a catalyst for an electrochemical cell, wherein:
a graphited porous carbon material is treated with an oxygen-containing plasma or an aqueous medium containing an oxidising agent,
at least one noble metal compound is deposited on the treated carbon material,
the impregnated carbon material is brought into contact with a reducing agent such that the noble metal compound is reduced to a metallic noble metal.

The present invention relates to a catalyst which can be used in an electrochemical cell—in particular, a PEM fuel or PEM electrolytic cell—and has a high stability.

Noble metals such as platinum (as elemental metal or in the form of an alloy) are used as catalysts in polymer electrolyte membrane fuel cells (“PEM” fuel cells). Both the hydrogen oxidation at the anode and the oxygen reduction at the cathode can be catalyzed by platinum or another suitable noble metal; see, e.g., “PEM Fuel Cell Electrocatalysts and Catalyst Layers,” published by: J. Zhang, 2008, Springer Verlag, pp. 110-115, with regard to cathodic oxygen reduction (“ORR,” “oxygen reduction reaction”), and pp. 149-156, with regard to anodic hydrogen oxidation (“HOR,” “hydrogen oxidation reaction”).

In order to generate a high electrochemically-active surface area, the catalytically-active, platinum-containing material is frequently provided in the form of nanoparticles on a substrate material. Carbon materials are frequently used as substrates.

The carbon materials used as substrates may be porous. Production methods with which the porosity can be adjusted in a targeted manner are known to the person skilled in the art. In the case of a production method also called “nanocasting,” a porous inorganic solid (also referred to as a template or host structure) is first applied and infiltrated with an organic precursor. By means of a thermal treatment, the organic precursor present in the pores of the inorganic template is carbonized, and a carbonized carbon material is formed which has a higher proportion of carbon atoms than the organic precursor. The inorganic template is then removed, e.g., by the action of an acid or base, and the carbonized, carbon-rich material is exposed. The “nanocasting” method and the possible uses of the porous carbon materials produced therewith (for example, as substrate material of catalytically-active metals) are described, for example, by J. Yu, Accounts of Chemical Research, 46, 2013, pp. 1,397-1,406; P. Strasser et al., Chem Phys Chem, 13, 2012, pp. 1,385-1,394; and Ch. Neumann et al., Journal of Materials Chemistry, 22, 2012, pp. 10,787-10,794.

Under the operating conditions of a PEM fuel cell, there can be an oxidative corrosion of the carbon material that is functioning as a substrate, and, as a result of this damage to the substrate material, there can be a drop in power in the fuel cell.

For example, depletion of the fuel hydrogen (oxidizing partner of the overall reaction) can occur on the anode side during the operation of a PEM fuel cell. This phenomenon is known as hydrogen depletion and leads to the polarity reversal of the electrode voltage (“fuel cell reversal”). This results in the carbon oxidizing (C to CO₂) and eventually in the collapse of the porous electrode structure as well as the drop in power. Even during start-up or shut-down of the fuel cell, it can lead, on the cathode side, to an oxidative degradation of the carbon material.

It is known that the corrosion stability of a carbon material in a PEM fuel cell can be improved—in particular, also in the case of a reversal in polarity of the electrode voltage or during the start-up or the shut-down of the fuel cell—if the carbon material has been graphitized; see, e.g., C. Zhang et al., Catalysts, 2016, 6, 197, doi: 10.3390/cata16120197; and C. Liu et al., J. Mater. Chem. A, 2017, 5, pp. 1,808-1,825.

Graphitized carbon is understood to mean a carbon material which, as a result of a thermal treatment of a graphitizable starting material at high temperature, has at least partially a graphite structure; see, e.g., H. B. Bohm et al., Pure & Appl. Chem., 67, 1995, pp. 473-506. The graphite structure reveals itself, for example, by corresponding diffraction reflections in an X-ray diffractogram.

However, graphitization can lead to a reduction in the specific surface area of the carbon material and/or of the adhesive strength of the platinum particles on the carbon surface.

EP 2 954 951 A1 describes a method for producing a noble-metal-loaded, porous, graphitized carbon material. In this method, a porous inorganic solid acting as a template is initially added, and the pores thereof are subsequently impregnated with a liquid, organic starting compound (“precursor”). After carbonization of the organic starting compound to form a carbonized carbon material, the inorganic template is removed. The exposed carbonized carbon material is graphitized by a thermal treatment, and this graphitized carbon material is then subjected to an activation treatment in an oxidizing atmosphere. The activation treatment is carried out in air at a temperature of 400-500° C. The activated graphitized carbon material functions as a substrate for platinum metal particles. The supported composition can be used as a catalyst in an electrochemical cell (e.g., a fuel cell).

An aim of the present invention is to provide a catalyst with high corrosion stability under the operating conditions of a PEM fuel cell or PEM electrolytic cell. When used in a PEM fuel cell, the catalyst should exhibit high corrosion resistance even in the event of hydrogen depletion on the anode side or during the start-up or shut-down on the cathode side. Preferably, the high stability should not be achieved at the cost of a reduced activity, e.g., a low electrochemically-active surface area (EASA).

The aim is achieved by a method for producing a catalyst for an electrochemical cell, wherein
a graphitized, porous carbon material is treated with an oxygen-containing plasma or an aqueous medium containing an oxidizing agent,
at least one noble metal compound is deposited on the treated carbon material such that an impregnated carbon material is obtained,
the impregnated carbon material is brought into contact with a reducing agent such that the noble metal compound is reduced to a metallic noble metal, and a noble-metal-loaded carbon material is obtained.

Graphitized, porous carbon materials are known to the person skilled in the art and can be prepared by known methods or are commercially available. For example, a porous, graphitizable, carbon material is subjected to a thermal treatment (for example, at a temperature in the range of 1,400° C. to 3,000° C.), so that regions with graphite structure form in the carbon material.

In one embodiment, the graphitized, porous carbon material has, for example, a degree of graphitization of at least 60%, and more preferably at least 63%. For example, the degree of graphitization is in the range of 60-90%, and more preferably 63-80%.

As is known to the person skilled in the art and described, for example, in EP 2 954 951 A1, the degree of graphitization g (in %) can be determined by means of the following formula (1):

g=[(344 pm−d₀₀₂)/(344 pm−335.4 pm)]×100 (1)

where d₀₀₂ is the graphite-basal plane distance, which is determined using the known Bragg equation on the basis of the diffraction reflection of the (002) plane in the powder diffractogram of the graphitized carbon material.

In a further embodiment, the graphitized, porous carbon material has, for example, an La/Lc ratio of at least 0.15. Preferably, the ratio of La to Lc is 0.15 to 3.0, and more preferably 0.15 to 1.5 or 0.15 to 0.5. As is known to the person skilled in the art, La and Lc are a measure of the average crystallite sizes in a parallel direction (La) and in a perpendicular direction (Lc) to the basal planes of the graphite structure. As will be described in more detail below, La and Lc are determined in a known manner by powder diffractometry and application of the Scherrer equation. The determination of the La value is made on the basis of the diffraction reflection of the (100) plane (“100 diffraction reflection”), and the determination of the Lc value is made on the basis of the diffraction reflection of the (002) plane (“002 diffraction reflection”) in the powder diffractogram of the graphitized carbon material.

The graphitized, porous carbon material can be obtained, for example, by first subjecting an organic starting compound (organic “precursor”) to carbonization in order to obtain a carbonized carbon material and then by this carbonized carbon material being graphitized. As is known to the person skilled in the art, in the case of a carbonization, an organic precursor is thermally treated in an inert atmosphere (pyrolysis), wherein a solid is obtained as the carbonization product, which solid has a higher carbon content than the precursor. The carbonization takes place, for example, at a temperature of 500° C. to 1,200° C., and more preferably 500° C. to 900° C. or 700° C. to 900° C. As described in more detail below, the carbonization of the organic precursor can take place, for example, in the pores of an inorganic template material. For this case, it may be preferable for the carbonization temperature to be 500° C. to 900° C. or 700° C. to 900° C. in order to avoid a reaction between the inorganic template material and the carbonization product. The graphitization takes place, for example, at a temperature in the range of 1,400° C. to 3,000° C., and more preferably 2,000° C. to 2,500° C.

Suitable organic starting compounds which can be converted into a graphitized carbon material via carbonization and graphitization are known to the person skilled in the art. For example, the organic starting compound is a polyhydroxy compound or a pitch.

The polyhydroxy compound is, for example, a saccharide, a polyvinyl alcohol, or a phenolic resin. For example, a monosaccharide, a disaccharide, an oligosaccharide (3-10 saccharide units), or a polysaccharide (e.g., starch) can be used as the saccharide.

Pitches are residues from the distillation of tar. Depending upon the origin, a distinction can be made, for example, between coal tar pitches, wood tar pitches, petroleum pitches, tall oil pitches, or fish oil pitches. Pitches are generally thermoplastic materials.

In a preferred embodiment, the graphitized, porous carbon material is obtainable by a method, or the graphitized, porous carbon material is produced by a method, comprising the following steps:
a porous inorganic solid is impregnated with an organic starting compound,
the organic starting compound present in the porous inorganic solid is carbonized so that a carbonized carbon material is obtained,
the inorganic solid is removed,
the carbonized carbon material exposed by the removal of the inorganic solid is graphitized.

With regard to suitable organic starting compounds, reference can be made to the above statements. In a preferred embodiment, a polyhydroxy compound is used as an organic starting compound, with which the porous inorganic solid is impregnated. In the context of the present invention, it has been found that a further improvement in the oxidative stability and in the electrochemically-active surface area of the catalyst composition can be achieved if the graphitized, porous carbon material was produced using a polyhydroxy compound (for example, a saccharide, a polyvinyl alcohol, or a phenolic resin).

Suitable porous solids which can be used as a template in the nanocasting are known to the person skilled in the art. For example, the porous solid is SiO₂, Al₂O₃, or a transition metal oxide. The porous inorganic solid can consist, for example, of particles connected to one another, wherein the cavities between the particles represent the pore volume for the absorption of the organic precursor. Inorganic templates which can be used for the nanocasting are, for example, described by J. Yu, Accounts of Chemical Research, 46, 2013, pp. 1,397-1,406; P. Strasser et al., Chem Phys Chem, 13, 2012, pp. 1,385-1,394; and Ch. Neumann et al., Journal of Materials Chemistry, 22, 2012, pp. 10,787-10,794; and in EP 2 954 951 A1 and EP 2 528 879 Bl.

For the impregnation step, the organic starting compound is preferably present in liquid form (for example, in molten or dissolved form). The inorganic, porous, solid body is brought into contact with the liquid, organic starting compound, so that the organic starting compound can diffuse into the pores of the inorganic solid body.

With regard to a suitable carbonization temperature of the organic starting compound present in the inorganic, porous, solid body, reference can be made to the above statements. The carbonization takes place, for example, at a temperature of 500° C. to 1,200° C., and more preferably 500° C. to 900° C. or 700° C. to 900° C. The carbonization takes place in an inert gas atmosphere—for example, under argon or preferably under nitrogen. A solid which has a higher carbon content than the organic starting compound is obtained as a carbonization product. In order to keep the risk of a reaction between the inorganic solid and the carbonized carbon material as low as possible, carbonization preferably takes place at 500° C. to 900° C. or 700° C. to 900° C.

Methods with which the inorganic solid can be removed without significantly impairing the carbonized carbon material are known to the person skilled in the art. For example, the inorganic solid is removed by the action of an acid or a base.

With regard to a suitable graphitization temperature of the carbonized carbon material exposed by the removal of the inorganic solid, reference can be made to the above statements. The graphitization takes place, for example, at a temperature in the range of 1,400° C. to 3,000° C., and more preferably 2,000° C. to 2,500° C.

Suitable graphitized, porous carbon materials are also commercially available—for example, under the Porocarb® label from Heraeus.

The porous, graphitized carbon material has, for example, a specific BET surface area in the range of 5 m²/g to 200 m²/g, and preferably 10 m²/g to 100 m²/g or 30-80 m²/g.

The porous, graphitized carbon material has, for example, a pore volume of 0.7 cm³/g to 3.5 cm³/g, and preferably 0.9 cm³/g to 2.5 cm³/g. For example, at least 75% of the pore volume is taken up by macropores having a pore diameter in the range of 100 nm to 5,000 nm.

In a preferred embodiment, the porous, graphitized carbon material has an La/Lc ratio in the range of 0.15 to 0.5 and a specific BET surface area in the range of 30-80 m²/g.

In the method of the present invention, the graphitized, porous carbon material described above is treated with an oxygen-containing plasma or an aqueous medium containing an oxidizing agent.

The plasma is, for example, a low-pressure plasma or a normal-pressure or atmospheric-pressure plasma. In the case of a low-pressure plasma, a gas having a relatively low pressure is used for the generation of the plasma—for example, 0 mbar or even mbar. In the case of a normal pressure plasma, plasma generation takes place approximately at atmospheric pressure (1 bar+/−0.1 bar).

The gas used for the generation of the oxygen-containing plasma contains oxygen (O₂), or even consists of oxygen. In addition to oxygen, the oxygen-containing gas can also contain, for example, one or more inert gaseous components. The oxygen-containing gas used for plasma generation is, for example, air or O₂-enriched air. It can also, for example, be O₂ in a mixture with one or more noble gases. Preferably, the gas used for the generation of the oxygen-containing plasma comprises oxygen (O₂) at a concentration of at least 20 vol %, and more preferably at least 95 vol %.

The plasma is operated, for example, at a power of 50 W to 250 W.

The graphitized, porous carbon material is treated with the oxygen-containing plasma for a period of 10 minutes to 60 minutes, for example.

The oxidizing agent present in the aqueous medium is, for example, HNO₃, H₂SO₄, a permanganate (e.g., KMnO₄), H₂O₂, or a mixture of at least two of the aforementioned oxidizing agents (e.g., a mixture of HNO₃ and H₂SO₄).

The oxidizing agent is present in the aqueous medium, for example, in a concentration of at least 20 wt %—for example, 20 wt % to 80 wt %.

In a preferred embodiment, the oxidizing agent is HNO₃. The aqueous medium containing HNO₃ is, for example, concentrated nitric acid. The HNO₃ content of the commercially available, concentrated nitric acid is known to be about 69 wt %.

The temperature of the aqueous medium during the treatment of the graphitized, porous carbon material is, for example, 70° C. to 100° C., and more preferably 80° C. to 95° C.

The graphitized, porous carbon material is treated with the aqueous, oxidizing-agent-containing medium for a period of 30 minutes to 180 minutes, for example. It can then be washed with water and dried.

The graphitized, porous carbon material treated with the oxygen-containing plasma or the oxidizing-agent-containing, aqueous medium has, for example, an oxygen content, determined by X-ray photoelectron spectroscopy (XPS), in the range of 0.1 to 10 at %, and preferably 0.5 to 5 at %. In the Raman spectrum, the graphitized, porous carbon material treated with the oxygen-containing plasma or the oxidizing agent-containing, aqueous medium has, for example, a G-band and a D-band, the intensity ratio I_{G}/I_{D} of which is at least 2.7, and more preferably at least 3.3. For example, I_{G}/I_{D} is in the range of 2.7 to 4.2, and more preferably 3.3 to 3.9. As is known to the person skilled in the art, the G-band appears at about 1,582 cm⁻¹, and the D-band appears at approximately 1,350 cm⁻¹.

As stated above, a noble metal compound is deposited on the carbon material previously treated with the oxygen-containing plasma or the aqueous oxidizing-agent-containing medium so that an impregnated carbon material is obtained.

The noble metal is preferably a metal of the platinum metal group—in particular, platinum.

In a preferred embodiment, the deposition of the noble metal compound on the carbon material occurs in an aqueous medium.

Platinum compounds which can be used for impregnating a substrate material (preferably in aqueous medium) and a subsequent reduction to metallic platinum are known to the person skilled in the art.

For example, the platinum compound is a Pt(II) or a platinum(IV) compound—for example, a Pt(II) or Pt(IV) salt or a Pt(II) or Pt(IV) complex or a Pt organometallic compound. Exemplary platinum compounds may be hexachloroplatinic acid or a salt of this acid, a platinum nitrate, a platinum halide, platinum acetylacetonate or platinum oxalate, or a mixture of at least two of these compounds.

If the metallic platinum particles to be produced with the method according to the invention are still to contain an alloying element, one or more metal compounds can also be added to the aqueous medium in addition to the platinum compound. In this case, the carbon material acting as a substrate is impregnated not only with the platinum compound, but also with the additional metal compound. This further metal compound can, for example, be a noble metal or another transition metal. This further compound can, for example, be a salt, a complex, or an organometallic compound.

For the impregnation step, the carbon material and the platinum compound to be deposited thereon can be introduced simultaneously or also in succession into the aqueous medium. For example, the carbon material is first dispersed in the aqueous medium, and then the platinum compound (for example, in the form of an aqueous solution) is metered in.

Suitable conditions for impregnating the carbon material with the platinum compound are known to the person skilled in the art. Preferably, the aqueous medium is stirred continuously during the impregnation step.

The pH of the aqueous medium can be varied over a wide range during the impregnation step. For example, during the impregnation step, the aqueous medium has a pH of at most 9.5; and more preferably at most 6.0.

During the impregnation step, the temperature of the aqueous medium is, for example, 20° C. to 95° C., more preferably 40° C. to 90° C. or 60° C. to 80° C., and in particular 50° C. to 70° C.

The mass ratio of the platinum present in the platinum compound to the carbon material is, for example, 1/10-8/10, and more preferably 2/10-7/10.

The carbon material is present in the aqueous medium in, for example, a quantity of 0.05 wt % to 2.5 wt %, and more preferably 0.1 wt % to 2.0 wt %.

The duration of the impregnation step is selected such that the platinum compound can be deposited in sufficient quantity on the carbon material that functions as a substrate material. A suitable duration can be determined by the person skilled in the art on the basis of routine experiments.

During the impregnation step, the platinum compound is adsorbed on the surface of the carbon material. Because the carbon material is porous, it is, in particular, an inner surface, i.e., a surface lying within the pores. As a result of the impregnation step, an impregnated (i.e., loaded with the platinum compound) carbon material is obtained.

As mentioned above, the impregnated carbon material is brought into contact with a reducing agent such that the noble metal compound is reduced to a metallic noble metal and a noble-metal-loaded carbon material is obtained.

As already mentioned above, the metallic noble metal can be an elemental noble metal (e.g., elemental platinum) or a noble metal alloy (e.g., a Pt alloy), wherein the noble metal in the case of an alloy preferably represents the component present in the highest concentration, in wt %, in the alloy.

The reduction step preferably takes place in an aqueous medium.

For the reduction step, the aqueous medium has, for example, a pH in the range of 1.5-7.0.

As a result of the contact with the reducing agent, a noble metal—preferably metallic platinum—is formed on the carbon material—for example, in the form of particles. The noble-metal-loaded carbon material produced by the method according to the invention contains the noble metal (preferably platinum) in, for example, a quantity of 5 wt % to 60 wt %, and more preferably 15 wt % to 50 wt % or 25 wt % to 50 wt %.

Formic acid, a metal borohydride (e.g., an alkali metal borohydride such as NaBH₄ and LiBH₄), an alkali metal hydride (e.g., sodium hydride), hydrogen (H₂), a metal thiosulfate (e.g., an alkali metal thiosulfate such as NaS₂O₃), an aldehyde (e.g., formaldehyde), an alcohol (e.g., a monohydroxy alcohol such as isopropanol), hydrazine, hydrazine hydrate, hydrazine hydrochloride or ascorbic acid, or a mixture of at least two of these reducing agents, to name a few examples, can be used as the reducing agent.

On the basis of his technical knowledge, the person skilled in the art can determine a suitable temperature for the reduction step (i.e., a suitable temperature of the aqueous medium during the reduction step) as a function of the reducing agent that is used. For the reduction step, the temperature of the aqueous medium is, for example, in the range of 20° C. to 95° C., more preferably 30° C. to 90° C., even more preferably 50° C. to 80° C., and in particular 50° C. to 70° C.

After reduction of the noble metal compound to the noble metal (which may be an elemental noble metal or a noble metal alloy), the catalyst composition can be isolated from the aqueous medium by conventional methods and subjected to drying.

The present invention also relates to a catalyst for an electrochemical cell obtainable by the method according to the invention described above.

The catalyst comprises a graphitized carbon material and a noble metal present on this carbon material—in particular, platinum.

With regard to preferred properties of the graphitized carbon material, reference can be made to the statements made above.

In a preferred embodiment, the catalyst is obtainable by a method comprising the following steps:
a porous inorganic solid is impregnated with a polyhydroxy compound— in particular, a saccharide, a polyvinyl alcohol, or a phenolic resin,
the polyhydroxy compound present in the porous inorganic solid is carbonized—preferably at a temperature in the range of 500-900° C.—so that a carbonized carbon material is obtained,
the inorganic solid is removed,
the carbonized carbon material exposed by the removal of the inorganic solid is graphitized—preferably at a temperature in the range of 1,400-3,000° C., and more preferably 2,000-2,500° C.—so that a graphitized, porous carbon material is obtained,
the graphitized, porous carbon material is treated with an oxygen-containing plasma or an aqueous medium that contains an oxidizing agent,
in an aqueous medium, a platinum compound is deposited on the treated carbon material so that an impregnated carbon material is obtained,
the impregnated carbon material is brought into contact with a reducing agent such that the platinum compound is reduced to metallic platinum and a platinum-loaded carbon material is obtained.

The present invention further relates to an electrochemical cell containing the catalyst according to the invention.

The electrochemical cell is preferably a polymer-electrolyte fuel cell or a polymer-electrolyte electrolytic cell (for water electrolysis).

The measurement methods used in the present invention are specified below.

Measurement Methods

Powder Diffractometry

The degree of graphitization and the crystallite sizes La and Lc were determined by powder diffractometry.

Powder diffractometry was measured on a STOE & Cie. Stadi P diffractometer in powder transmission geometry. A focusing Ge-111 monochromator provides monochromatic copper Kₐₗₚₕₐ₁ X-ray radiation at λ=1.54060 Å (generator parameters: 40 kV, 30 mA). Sample materials of a few mg were finely comminuted in an axis mill, fixed between cellophane films with white glue, and installed in the STOE transmission sample holder. The STOE IPPSD detector was used. The samples were rotated in the transmission sample holder in the plane perpendicular to the X-ray beam at 50-150 rpm. The STOE WinXPOW software was used for sample collection. Measurements were carried out in a 2theta range of 8° to 84°; the recording time was 8,800 seconds. The 2theta increment is 0.015°.

Degree of Graphitization

The degree of graphitization g (in %) is determined by the following formula (1):

g=[(344 pm−d₀₀₂)/(344 pm−335.4 pm)]×100 (1)

where d₀₀₂ is the graphite-basal plane distance, which is determined by the known Bragg equation on the basis of the diffraction line of the (002) plane in the powder diffractogram of the graphitized carbon material.

The Bragg equation known to the person skilled in the art is as follows:

d=(n*λ)/(2*sin Θ)
where
λ is the X-ray wavelength,
n is the order of diffraction, and
Θ is the Bragg angle.

Determination of the Crystallite Sizes La and Lc

The crystallite sizes La and Lc were determined by the full width at half maximum (FWHM) of the 100 (La, 2theta=42.223°) and 002 (Lc, 2theta=26.382°) reflections of the hexagonal graphite structure having been adapted via a peak fit. For this purpose, the STOE crystallinity analysis software was used. This software uses the Scherrer method or Scherrer equation, which is known to the person skilled in the art. A LaB₆ sample was used to determine the instrumental expansion; this instrumental expansion was subtracted from the fitted FWHM value before the calculation. The Scherrer equation known to the person skilled in the art is as follows:

L=(K*λ)/(β−βᵢₙₛₜ)*cos Θ))

where
L is the average crystallite size,
K is a form factor,
λ is the X-ray wavelength,
β is the full width at half maximum (“FWHM”) of the reflection,
βᵢₙₛₜ is the full width at half maximum (“FWHM”) of the LaB₆ standard,
Θ is the Bragg angle.

A form factor of 0.9 is used in each case for La and Lc.

Specific BET Surface Area

The specific BET surface area was determined with nitrogen as adsorbate at 77 K in accordance with BET theory (multipoint method, ISO 9277:2010).

Pore Volume and Pore Diameter Distribution

The pore volume and pore diameter distribution were determined with mercury porosimetry in accordance with ISO 15901-1:2016. The procedure was as follows: sample mass 30 mg; surface tension of mercury 0.48 N/m; contact angle of mercury 140.0°; instrument: Porotec Pascal 140+440; measurement method: scanning; start filling pressure 0.0128 mPa; dilatometer: powder, small volume; sample preparation: 8 h at 110° C. under vacuum.

Content of Noble Metal (e.g., Platinum)

The noble metal content was determined via optical emission spectrometry with inductively-coupled plasma (ICP-OES).

Determination of the Electrochemically-Active Surface Area (EASA):

The electrochemically-active surface area was determined from the measured charge of the hydrogen underpotential deposition. For this purpose, the polarization curves in argon-saturated electrolytes at a potential feed rate of 50 mVs⁻¹ were used. The charge is obtained after subtraction of the electrochemical, double-layer capacitance from the integration of the current over the time. A conversion factor of 200 μCcm⁻² was used for determining the platinum surface area.

Oxygen Content

The oxygen content is determined by X-ray photoelectron spectroscopy (XPS). The measurements were carried out on an X-ray photoelectron spectrometer (device PHI 5800 ESCA system) with an X-ray excitation at 15 kV Mg radiation (non-monochromated) and a measurement duration of 10 min. The concentration determination was based upon sensitivity factors of elementary standards.

Raman Spectrum, G- and D-Band Intensity Ratio

Raman spectra from the respective sample were recorded at three different measuring points with the laser excitation at 532 nm, a power of about 1.6 mW (3.2%), and an excitation duration of 30 sec. First, spectral smoothing (de-noising) and then a baseline correction were carried out on the recorded spectra using the spectrometer software. The relevant bands were calculated using deconvolution (band separation).

The invention is explained in more detail with reference to the following examples.

### EXAMPLES

### Example 1 According to the Invention (EB1)

In EB1, a graphitized, porous carbon material was produced via nanocasting by a porous SiO₂ template being impregnated with saccharose, the saccharose being carbonized, the SiO₂ template being removed, and the carbonized carbon material being graphitized.

Treatment with Oxygen-Containing Plasma

The graphitized, porous carbon material was treated with an oxygen-containing plasma. For the plasma generation, was pure oxygen, pressure: 0.3 mbar (low pressure plasma); power: 200 W. Plasma treatment took 30 min.

Deposition of a Platinum Compound on the Plasma-Treated Carbon Material

6 g of the plasma-treated carbon material were slurried with 100 mL of water, added to a double-shell reactor, and filled to 2 L with water. The mixture was stirred and the suspension heated to 70° C. After a holding time of 1 hour, 40 g of a nitric acid Pt-nitrate solution (10 wt % of Pt) were metered in and then kept for 1 hour under constant mixing and temperature.

Reduction to Metallic Platinum

By addition of Na₂CO₃, the pH of the aqueous medium was adjusted to a value of 5.6. This was followed by the addition of formic acid, which served as a reducing agent. The mixture was stirred, and the temperature of the aqueous medium was 70° C. During the reduction, the platinum compound present on the carbon material was reduced to metallic platinum. This yielded a carbon material laden with metallic platinum. After 0.5 hours, the catalyst composition was filtered off from the aqueous medium and washed with water, and dried at 110° C. under a nitrogen atmosphere. The platinum content of the catalyst composition was 40 wt %.

### Example 2 According to the Invention (EB2)

The substrate used in EB2 is likewise a graphitized, porous carbon material produced by nanocasting by a porous SiO₂ template having been impregnated with saccharose, the saccharose having been carbonized, the SiO₂ template having been removed, and the carbonized carbon material having been graphitized.

Treatment with an Aqueous Medium Containing Oxidizing Agents

The graphitized, porous carbon material was dispersed at 70° C. for 180 min in 69 wt % nitric acid while being stirred. After removal from the nitric acid, the treated carbon material was washed with water and dried.

Deposition of a Platinum Compound on the Treated Carbon Material

6 g of the carbon material treated in the oxidizing-agent-containing aqueous medium were impregnated with a platinum compound under the same conditions as in example EB1.

Reduction to Metallic Platinum

The reduction to metallic platinum took place under the same conditions as in example EB1. The platinum content of the catalyst composition was 40 wt %.

### Comparative Example 1 (VB1)

As in examples EB1 and EB2 according to the invention, the graphitized, porous carbon material used in comparative example VB1 was produced by nanocasting. A porous SiO₂ template was impregnated with pitch P15 from Rain Carbon, Inc., as an organic precursor compound, the precursor compound was carbonized, the SiO₂ template was removed, and the carbonized carbon material was graphitized.

Thermal Treatment in Air

The graphitized, porous carbon material was subjected to thermal treatment in air at 430° C. for 13 hours.

Deposition of a Platinum Compound on the Treated Carbon Material

6 g of the carbon material thermally treated in air were impregnated with a platinum compound under the same conditions as in example EB1.

Reduction to Metallic Platinum

The reduction to metallic platinum took place under the same conditions as in example EB1. The platinum content of the catalyst composition was 40 wt %.

Investigation of the Start-Up/Shut-Down (SUSD) Cycle Stability of the Catalyst Compositions Prepared in EB1, EB2, and VB1:

Test cells were prepared with the catalyst compositions produced in EB1, EB2, and VB1, and the cell voltage was determined as a function of the number of start-up/shut-down cycles. The SUSD tests were carried out as described by Gasteiger et al. in Journal of the Electrochemical Society, 165 (16) F1349-F1357 (2018).

The results were as follows:

EB1: 90% of the original voltage after 220 SUSD cycles
EB2: 90% of the original voltage after 240 SUSD cycles
VB1: 90% of the original voltage after 70 SUSD cycles

Compared to the test cell with the catalyst composition produced in VB1, the test cells with the catalyst compositions produced in EB1 and EB2 show a significantly smaller decrease in the cell voltage as a function of the SUSD cycle number. This is due to the higher corrosion stability of the catalyst.

TABLE 1
Results of the SUSD tests

| | | Number of SUSD cycles at 90% |
|---|---|---|
| | Activation treatment | of the original voltage |
| EB1 | Plasma | 220 |
| EB2 | Oxidative aqueous | 240 |
| | medium | |
| VB1 | Air, | 70 |
| | 400-500° C. | |

Electrochemically-Active Surface Area (EASA)

The electrochemically-active surface area was determined in each case for the catalyst compositions prepared in EB1 and VB1. The results are listed in Table 2.

TABLE 2
Electrochemically-active surface areas EASA

| | Activation | EASA |
|---|---|---|
| | treatment | [m² Pt/g Pt] |
| EB1 | Plasma | 49.7 |
| VB1 | Air, | 33.5 |
| | 400-500° C. | |

The catalyst composition prepared with the method according to the invention has a significantly higher electrochemically-active surface area than does a catalyst composition whose carbon substrate was thermally treated in air before noble metal deposition.

1. A method for producing a catalyst for an electrochemical cell, the method comprising:
treating a graphitized, porous carbon material with an oxygen-containing plasma or an aqueous medium containing an oxidizing agent,
depositing at least one noble metal compound on the treated carbon material such that an impregnated carbon material is obtained, and
bringing the impregnated carbon material into contact with a reducing agent such that the noble metal compound is reduced to a metallic noble metal and a noble-metal-loaded carbon material is obtained.

2. The method of claim 1, wherein the graphitized, porous carbon material has a degree of graphitization of at least 60%, wherein the degree of graphitization g is determined based upon the following formula (1):
g=[(344 pm−d₀₀₂)/(344 pm−335.4 pm)]×100 (1)
where d₀₀₂ is the graphite-basal plane distance determined by powder diffractometry on the basis of the diffraction reflection of the (002) plane; and/or the graphitized, porous carbon material has an La/Lc ratio of at least 0.15, determined by powder diffractometry, wherein La is the average crystallite size in the parallel direction and Lc is the average crystallite size in the perpendicular direction to the basal planes of the graphite structure.

3. The method of claim 1, wherein the graphitized, porous carbon material has a specific BET surface area, determined with nitrogen at 77 K in accordance with ISO 9277:2010, in the range of 5 m²/g to 200 m²/g and/or a pore volume, determined by mercury porosimetry in accordance with ISO 15901-1:2016, in the range of 0.7 cm³/g to 3.5 cm³/g.

4. The method of claim 1, wherein the graphitized, porous carbon material is obtained by converting a polyhydroxy compound into a carbonized carbon material via a carbonization and by graphitizing the carbonized carbon material.

5. The method of claim 4, wherein the polyhydroxy compound is a saccharide, a polyvinyl alcohol, or a phenolic resin.

6. The method of claim 4, wherein the graphitized, porous carbon material is obtained by a method comprising:
impregnating a porous inorganic solid with the polyhydroxy compound,
carbonizing the polyhydroxy compound present in the porous inorganic solid so that a carbonized carbon material is obtained,
removing the inorganic solid, and
graphitizing the carbonized carbon material exposed by the removal of the inorganic solid.

7. The method of claim 1, wherein a gas having an oxygen content of at least 20 vol % is used for the generation of the oxygen-containing plasma.

8. The method of claim 1, wherein the oxidizing agent present in the aqueous medium is HNO₃, H₂SO₄, a permanganate, H₂O₂, or a mixture of at least two of the aforementioned oxidizing agents.

9. The method of claim 1, wherein the deposition of the noble metal compound on the treated carbon material occurs in an aqueous medium.

10. The method of claim 1, wherein the metallic noble metal is platinum, and the noble metal compound is a platinum(II) or platinum(IV) compound.

11. The method of claim 1, wherein the impregnated carbon material is brought into contact with the reducing agent in an aqueous medium; and/or wherein the reducing agent is formic acid, a metal borohydride, an alkali metal hydride, hydrogen (H₂), a metal thiosulfate, an aldehyde, an alcohol, hydrazine, hydrazine hydrate, hydrazine hydrochloride, or ascorbic acid, or a mixture of at least two of these reducing agents.

12. The method of claim 1, wherein the noble-metal-loaded carbon material contains the noble metal in a quantity of 5-60 wt %.

13. Catalyst obtainable by the A catalyst produced by a method according to claim 1.

14. An electrochemical cell containing the catalyst of claim 13.

15. The electrochemical cell according of claim 14, wherein the electrochemical cell is a PEM fuel cell or a PEM electrolytic cell.

16. The method of claim 1, wherein a gas having an oxygen content of at least 95 vol % is used for the generation of the oxygen-containing plasma.
